(19) United States
(12) Patent Application Publication
(10) Pub. No.: US 2024/0300228 A1
(43) Pub. Date: Sep. 12, 2024

(54) A MULTILAYER POLYESTER COMPOSITE MATERIAL HAVING SELF-HEALING PROPERTIES

(71) Applicant: Seyed Sepehr Ershadi, Tehran (IR)

(72) Inventor: Seyed Sepehr Ershadi, Tehran (IR)

(73) Assignee: Seyed Sepehr Ershadi, Tehran, OT (IR)

(21) Appl. No.: 18/666,854

(22) Filed: May 17, 2024

Related U.S. Application Data
(63) Continuation-in-part of application No. PCT/IB2022/060684, filed on Nov. 7, 2022.

(30) Foreign Application Priority Data
Nov. 17, 2021 (IR) 14005014000300657

(51) Int. Cl. B32B 27/12; B32B 3/08; B32B 5/02; B32B 5/08; B32B 27/36; B32B 37/16

(52) U.S. Cl. CPC B32B 27/12; B32B 3/085; B32B 5/024; B32B 5/08; B32B 27/36; B32B 37/16; B32B 2262/0276; B32B 2262/062; B32B 2262/12; B32B 2305/188; B32B 2307/308; B32B 2307/7375; B32B 2307/762; B32B 2309/02; B32B 2367/00

(57) ABSTRACT

A multilayer self-healing polyester composite material and a method for its manufacture for lightweight application structures. The multi-layered self-healing polyester composite comprises a backing layer which is a textured polyester layer; a middle layer, a tufted pile of polyester fibers tufted on the backing layer; and an outer layer comprising a solid dense polyester layer that bonded to the middle layer. The solid dense polyester outer layer has self-healing properties. The outer surface layer of the self-healing polyester composite is created by a heating process of the tufted pile of polyester fibers. This process results in the formation of the solid dense polyester outer layer.

### CROSS-REFERENCE TO RELATED DISCLOSURE

This disclosure is a continuation-in-part of PCT international application PCT/IB2022/060684 filed on Nov. 7, 2022, entitled ‘A MULTILAYER POLYESTER COMPOSITE MATERIAL with SELF-HEALING PROPERTIES’, which claims priority from the granted IR patent application Ser. No. 14/005,0140003006577, filed on Nov. 17, 2021, both applications are incorporated herein by reference in their entirety.

### TECHNICAL FIELD

The present invention generally relates to a self-healing multi-layer polyester composite. More particularly, but not exclusively, the present invention relates to a self-healing composite comprising thermoplastic and thermoset polymers. The present disclosure also relates to a method of manufacturing and structure of self-healing multi-layer composite.

### BACKGROUND

Interlaminar delamination and the formation of surface cracks are common phenomena in composite materials, often triggered by external influences such as impact, fatigue, or intrinsic manufacturing defects, especially at the surface and interfaces. Delamination within composite structures can extend hundreds of microns along the direction of crack propagation and reach lengths of several centimeters, leading to the formation of substantial yet frequently imperceptible internal damage zones.

Interlaminar delamination and cracking in composite materials is a major challenge to detect since interlaminar delamination is very difficult to repair using conventional methods. This failure mechanism represents an important safety barrier for the use of composite materials in lightweight structures. Self-healing strategies, such as encapsulation of reactive fluids in microcapsules or microvascular systems, are promising methods to extend the lifetime of composites. Nevertheless, problems such as limited healing cycles, prolonged reaction times (from hours to days), and the stability of the chemical agents under different environmental conditions pose a constant challenge. In contrast, self-healing methods that utilize reversible bonding of the host material offer the potential for unlimited healing cycles. Moreover, the high cost of the self-healing materials can be considered another drawback of this method.

Therefore, there is a need to develop a process to produce a multi-layered self-healing composite with higher performance and lower cost.

### SUMMARY

The following summary is not intended to include all features and aspects of the present application, nor does it imply that the application must include all features and aspects discussed in this summary.

According to an exemplary embodiment, a multilayer self-healing polyester composite material and a method for its manufacture are disclosed herein.

In an exemplary embodiment, disclosed herein is the multi-layered self-healing polyester composite comprising a backing layer having two surfaces including a top surface and a bottom surface, a middle layer that may be a tufted polyester pile tufted on the top surface of the backing layer, and a solid polyester as an outer layer having self-healing properties.

In an exemplary embodiment, a method for manufacturing a multilayer self-healing polyester composite is described. The method involves several steps. Initially, a tufted pile of polyester fibers is formed on the top surface of a backing layer, while simultaneously, a layer of multitude yarn loops is formed on the bottom surface of the backing layer by tufting polyester yarns onto it. Subsequently, a solid polyester layer is formed as an outer layer by subjecting the tufted pile of polyester fibers on the top surface of the backing layer to heat at a temperature surpassing the material's glass transition temperature (Tg), followed by cooling to a specified temperature. This process results in the formation of the outer solid polyester layer on the surface of the tufted pile of polyester fibers. Importantly, the method produces a multilayer self-healing composite where the layers are detachably connected.

In an exemplary embodiment, the backing layer or base layer may be the textured layer preferably comprising polyester yarns.

In an exemplary embodiment, the heating step may be executed in a manner that ensures the multitude of yarn loops located on the bottom side of the backing layer remain undistorted.

In an exemplary embodiment, following the objectives outlined in this disclosure, as discussed in detail herein, the disclosure relates in one aspect to self-healing multilayer composite materials and the methods used in their fabrication. This method can be used to create self-healing composites or various structures including, but not limited to, fabrics comprising self-healing composite elements.

### BRIEF DESCRIPTION OF THE DRAWINGS

FIG. 1A illustrates a schematic of the backing layer (warp polyester yarns texture with weft polyester yarns), having two sides including a top surface and a bottom surface consistent with one or more exemplary embodiments of the present disclosure.

FIG. 1B illustrates a cross-sectional view of the formed tufted pile of polyester fibers alongside the multitude of yarn loops after tufting, consistent with one or more exemplary embodiments of the present disclosure.

FIG. 2A illustrates a cross-sectional schematic of a multi-layered polyester composite having self-healing properties, consistent with one or more exemplary embodiments of the present disclosure

FIGS. 2B and 2C illustrate respective perspective-view schematics of a multi-layered polyester composite having self-healing properties, consistent with one or more exemplary embodiments of the present disclosure.

FIG. 3 illustrates a flowchart detailing the manufacturing process of a multilayer self-healing polyester composite, consistent with one or more exemplary embodiments of the present disclosure.

FIG. 4 illustrates microscopic images of a multi-layered polyester composite: one before and one after undergoing a self-healing process, in line with exemplary embodiments of the present disclosure.

### DETAILED DESCRIPTION

The present disclosure pertains to a multi-layered polyester composite possessing self-healing properties. The layers are intricately sandwiched during the manufacturing process, rendering the separation of the layers unfeasible.

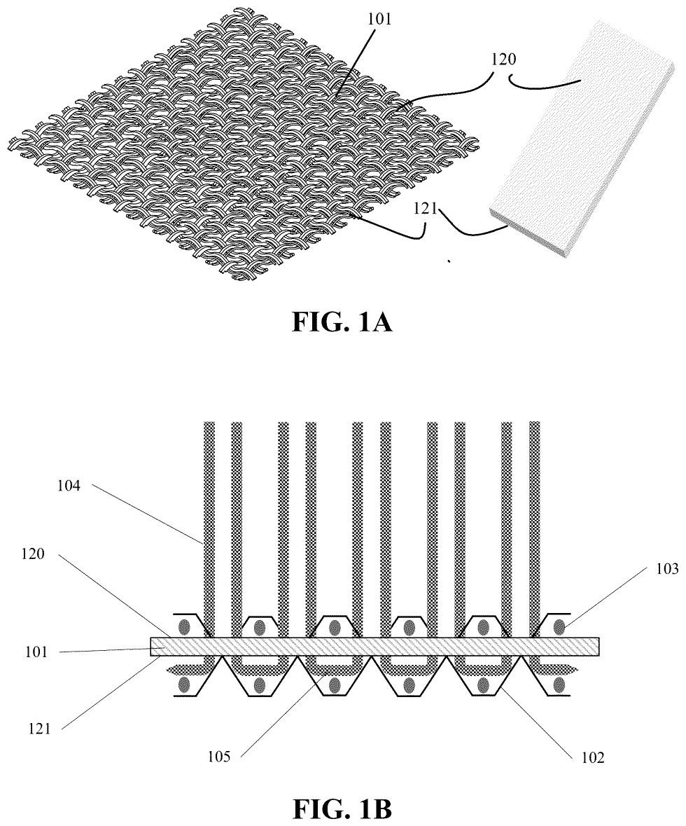

FIG. 1A illustrates a schematic of backing layer 101 of a multi-layered polyester composite 100 consistent with one or more exemplary embodiments of the present disclosure. According to an exemplary embodiment, backing layer 101 may be characterized by its texture of warp polyester yarns 102 interwoven with the weft polyester yarns 103 which are illustrated with more details in FIG. 1B.

In exemplary embodiments, as illustrated in FIG. 1A and FIG. 1B, the backing layer 101 may feature a top surface 120 on its top side and a bottom surface 121 on its bottom side. It should be noted that the use of the terms ‘top’ and ‘bottom’ is purely for descriptive purposes to indicate two sides of the layer, and these designations may be interchangeable and not limited to any specific orientation.

FIG. 1B presents a detailed cross-sectional schematic of two essential parts of the multi-layered polyester composite before being subjected to heat. In anexemplary embodiment, the composite comprises a tufted pile 104 of polyester fibers, situated as a middle layer on the top surface 120 of the backing layer 101, and a layer of multitude yarn loops 105, which formed simultaneously by tufting. In an exemplary embodiment, the tufted pile polyester 194 may be formed on the top surface 120 of the backing layer 101 while the multitude yarn loops 105 may be positioned on the bottom surface 121 of the backing layer 101. In an exemplary embodiment, the height of the tufted pile 104 may range from 0.1 to 20 cm. In an exemplary embodiment, the tufted pile of polyester fibers 104 on the top surface 120 of the backing layer 101 may be subjected to heat at a temperature surpassing the material's glass transition temperature (Tg), followed by cooling to a specified temperature to produce a multi-layer polyester composite.

In an exemplary embodiment, the multi-layered self-healing polyester composite 100 comprises the backing layer 101 that may be characterized by its texture of warp polyester yarns 102 interwoven with the weft polyester yarns 103; a tufted pile 104 of polyester fibers, as a middle layer. tufted on the top surface 120 of the backing layer 101, and an outer surface 121 formed as a solid dense polyester 106 may be formed as an external surface having self-healing properties.

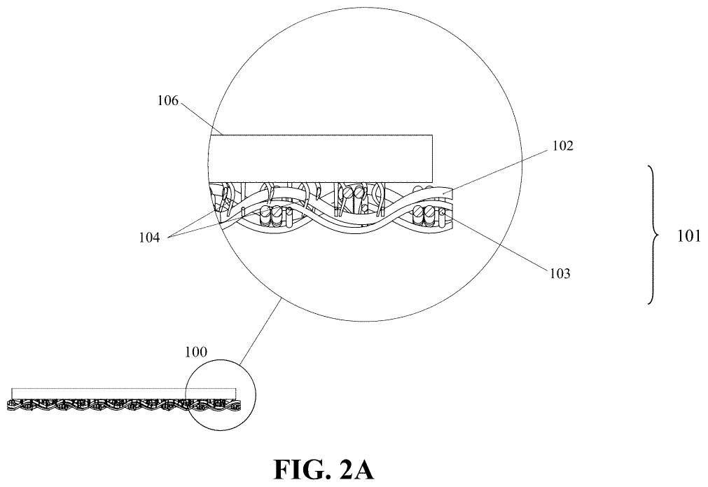

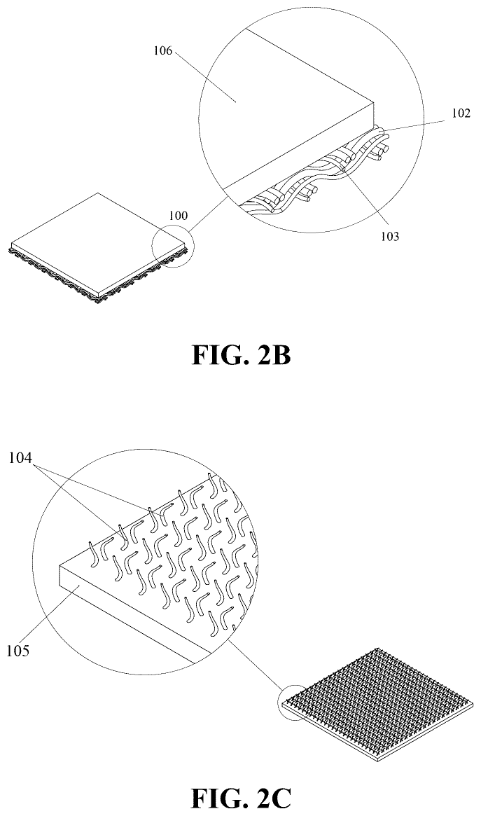

FIG. 2A illustrates a cross-sectional schematic of the multi-layered polyester composite 100 having self-healing properties, consistent with one or more exemplary embodiments of the present disclosure. In an exemplary embodiment, an outer layer 106 comprising a solid dense polyester layer may be bonded to the middle layer 104. In an exemplary embodiment of the present disclosure, the solid dense polyester layer 106 as an outer layer may be formed by heating the tufted pile of polyester fibers 104 on the top surface of the backing layer 101 at a temperature surpassing the material's glass transition temperature (Tg), followed by cooling to a specified temperature.

FIG. 2B and FIG. 2C depict perspective-view schematics of a multi-layered polyester composite endowed with self-healing properties, each providing a distinct side view. In FIG. 2B, the upper side view showcases the arrangement where the solid dense layer 106 serves as the outer layer, positioned atop the primary layer 101 comprised of warp polyester yarns 102 interwoven with weft polyester yarns 103. Conversely, in FIG. 2C, an exemplary embodiment is presented from the opposite side compared to FIG. 2B, highlighting the tufted pile polyester's placement and its adherence as a middle layer 104, alongside the formed solid dense polyester layer 106.

In an exemplary embodiment, the tufted pile of polyester fibers 104 as a middle layer 104, may comprise polyester lint that may be present on the top surface 120 of the backing layer 101.

In an exemplary embodiment, the backing layer 101 may constitute a textured layer, for example, interwoven warp yarns 102 with weft yarns 103. exemplary warp yarn 102 and weft yarn 103 may be of ae same type of composition or different types of compositions. In an exemplary embodiment, warp yarn 102 and weft yarn 103 of an exemplary elf-healing composite 100, may include polyester, nylon, polypropylene, Kevlar, acrylic, cotton, wool, and silk.

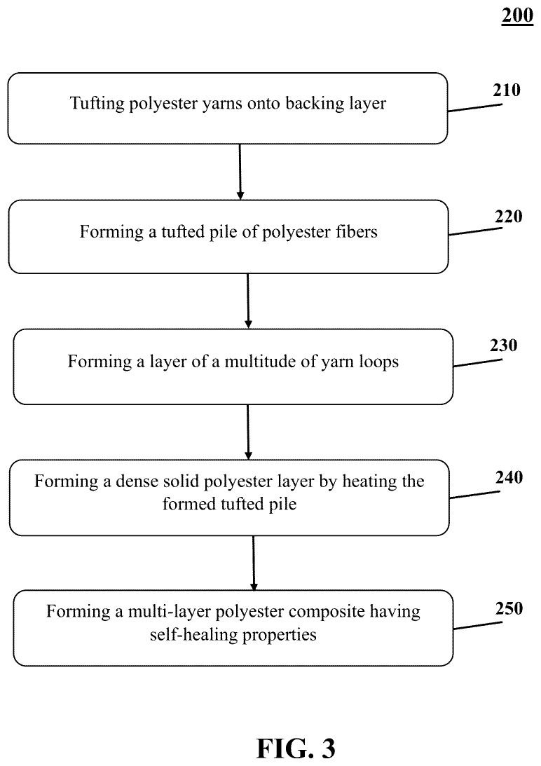

FIG. 3 shows flowchart 200 detailing the manufacturing process of a multilayer self-healing polyester. In an exemplary embodiment, a method for manufacturing the multi-layered self-healing polyester composite 100 may involve several steps as follows; Tufting polyester yarns onto a backing layer of the multilayer self-healing polyester (step 210); forming the tufted pile of polyester fibers on the top surface 120 of the backing layer (step 220); forming a layer of the multitude of yarn loops 230 on the bottom surface 121 of the backing layer 101 (step 230); and forming a solid polyester layer as an outer layer by heating the formed tufted pile of polyester fibers formed on the top surface of the backing layer 101 at a temperature exceeding the glass transition temperature (Tg) of the polyester (step 240).

According to an exemplary embodiment of the present disclosure, the process of manufacturing muti-layer polyester composite in step 210 may involve the process of tufting polyester yarns onto a backing layer. In an exemplary embodiment, tufting may refer to a method where loops of yarn are inserted through a backing material to create a pile or surface texture. In an exemplary embodiment, for tufting, a needle-like device may be employed to insert the fibers or yarns into the backing layer, thus forming a pile of fibers 104 on the top surface or loops 105 on the bottom surface 122 of the backing layer 101. IN an exemplary embodiment, employing tufting has the added advantage that the tufting bond extends uniformly over the whole backing layer. In an exemplary embodiment, tufting may create a layer of piles 104 on the backing layer 100. In an exemplary embodiment, the tufts may be inserted using vertically reciprocating needles, which penetrate through a pre-woven net of backing material, and may be secured beneath the backing layer by loopers.

In an exemplary embodiment of the process according to FIG. 3, forming the Tufted pile of polyester fibers on the top surface of the backing layer may occur. Following the tufting step 210, a tufted pile of polyester fibers is formed on the top surface 120 of the backing layer 101. This forms the basis for the subsequent layers of the composite. Simultaneously with step 220, a layer of a multitude of yarn loops 105 is formed on the bottom surface 121 of the backing layer (step 230). This layer enhances the structural integrity and self-healing properties of the composite.

In an exemplary embodiment of the process according to FIG. 3, a Solid Polyester Layer as an Outer Layer is formed (step 240). In one exemplary embodiment, the formed tufted pile of polyester fibers on the top surface of the backing layer may be subjected to heat at a temperature exceeding the glass transition temperature (Tg) of the polyester material. This elevated temperature may facilitate the formation of a solid polyester layer, serving as the outer layer of the composite. The bonding between this outer layer and the tufted pile of polyester fibers further reinforces the composite's structure.

In an exemplary embodiment of the present disclosure, the formation of the multi-layer polyester composite may be regarded as a final step. Within this step, the formed dense layer is cooled to a specific temperature, facilitating the formation of the multi-layer polyester composite.

In an exemplary embodiment, tufted piles 104 of polyester fibers may be polyester-based, a practical choice for recycling purposes. In an exemplary embodiment, alternative types of compositions, such as nylon or polypropylene may be used. In an exemplary embodiment, the polyester utilized in crafting the tufted pile 104 of fibers may originate from recycled materials, including polyester derived from bottles or discarded carpets. In an exemplary embodiment, the tufted pile 104 of polyester fibers may be employed in tufting the backing layer 101.

In an exemplary embodiment, the tufted pile 104 on the backing layer 101 may comprise bicomponent fibers. In an exemplary embodiment, these fibers may be composed of two components distributed throughout their entire length, namely polyester and cotton. In an exemplary embodiment, the polyester/cotton ratio may be 80/20. In an exemplary embodiment, utilization of bicomponent fibers may ensure a desirable uniform distribution of polyester and cotton within the tufted pile 104, resulting in a densely interconnected network predominantly composed of polyester components.

In an exemplary embodiment, the “melting temperature” or Tm of a material refers to the temperature at which it changes from a solid to a liquid state.

In an exemplary embodiment, the term “glass transition temperature”, abbreviated as Tg, refers to a temperature range within which the transition from a glassy to a liquid state occurs within a material. This transformation, also known as the glass-liquid transition or simply the glass transition, is characteristic of amorphous or semi-crystalline materials containing amorphous regions. During this transition, the material changes from a rigid or brittle state to a more viscous state as the temperature increases. Generally, if a material possesses a melting temperature, the Tg is typically lower.

In an exemplary embodiment, the melting temperature (Tm) of polyester may be at least 250-300° C., or greater than 300° C.

In an exemplary embodiment, an exemplary height of the tufted pile 104 of polyester fibers may range from 0.1 to 30 cm depending on the application of the composite. In an exemplary embodiment, the height of the tufted pile 104 of polyester fibers may be less than 0.1 mm or exceed 30 cm.

In an exemplary embodiment, outer surface layer 106 of the polyester composite may be formed through a heating process applied to the tufted pile 104 of polyester fibers. In an exemplary embodiment, this process may result in the formation of a solid, dense outer layer 106 of polyester, which is bonded to the tufted pile 104 of polyester fibers.

In an exemplary embodiment, heating may be applied either directly or indirectly. In an exemplary embodiment, the heating temperature may be set higher than the Tg point but lower than the Tm point. In an exemplary embodiment, the heating temperature may range from 130 to 200° C., depending on the dimensions of the polyester multilayer composite 100. In an exemplary embodiment, heating may be applied from five minutes to one hour. The heat treatment may be conducted from the side of the tufted pile 104 of polyester fibers. In the case of direct heating, the height of the heat source above the surface of the pile 104 of polyester fibers must be carefully regulated to prevent the deformation of the yarn loops 105 formed on the bottom surface 121 of the backing layer 101. This regulation ensures, thus maintaining the adhesion between the layers and the structural integrity of the composite.

In an exemplary embodiment, the term “self-healing”, as employed herein, may refer to the process herein of a material, once damaged, regenerating to its original undamaged state. In an exemplary embodiment, this recovery process may involve external assistance, e.g., by applying heat. In an exemplary embodiment, the ability of a multilayer polyester composite material to revert to a state where its properties are the same as those of the material before damage occurrence. In an exemplary embodiment, repair may involve repairing locations where cracks or fractures have emerged during the self-healing process. Furthermore, following self-healing, the material can be safely utilized for the intended application without an elevated risk of failure.

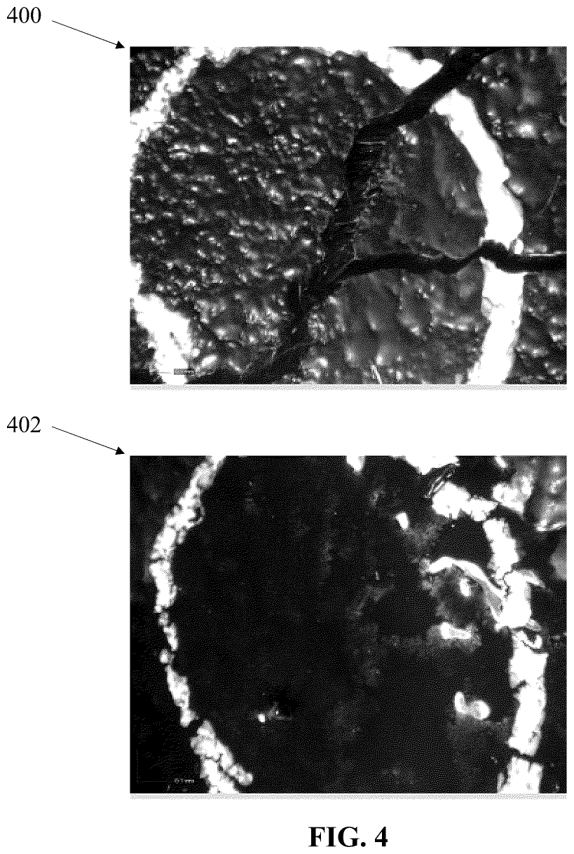

FIG. 4 depicts a microscopic image of a damaged multi-layered polyester composite before the self-healing process 400 and, additionally, a microscopic image of the same composite after undergoing the self-healing process 402 according to one exemplary embodiment of the present disclosure.

In the case of cracks or delamination within the composite, the self-healing process occurs “in place” so that the self-healing process allows it to be executed without the need to remove the multi-layer polyester composite 100 or separate its structural components. In an exemplary embodiment, to repair damaged areas, a heat source may be utilized to raise the temperature of the affected region, facilitating the flow of thermoplastic polymer materials (polyester) to the damaged areas. The applied heating temperature should exceed the Tg temperature of polyester, typically ranging from about 130 to 200° C. subsequent cooling to room temperature, results in the solidification of the polyester layer, thereby completing the self-healing process.

It should also be noted that the terminology used here serves to clarify certain aspects and is not intended to impose limitations. Unless expressly defined otherwise, all technical and scientific terms used herein have the same meaning as generally understood by those skilled in the relevant field to which the disclosed compositions and methods belong. Furthermore, it is to be understood that terms, including those described in generally recognized dictionaries, should be interpreted to be consistent with their contextual meaning within the specification and the relevant field, avoiding an overly rigid or abstract interpretation unless expressly stated herein. Additional terms may be explained elsewhere in this disclosure.

“Interlaminar delamination” represents a form of damage inherent to layered composite materials. As employed herein, “interlaminar delamination” signifies a separation or discontinuity between two plies or layers within a composite material.

The tensile strength of the multilayer self-healing polyester composite was measured using an Instron model 5566 manufactured in the United States. The movement speed of the gripper jaws holding the sample was set to 5 mm/min and the test was performed at room temperature with 3 repetitions. The tensile strength of the multilayer polyester composite with a thickness of 5 mm was 2102±18 N and that of the repaired damaged composite after the self-healing process 310 was 1980±23 N. The results show that the tensile strength of the composite decreased by less than 6% after the self-healing treatment.

The multilayer self-healing polyester composite of the present disclosure can be used in construction, the chemical industry, aircraft manufacturing, and aviation industry, the wood and forest industry, the metal industry, the stone industry, the cement industry, personal safety and protection equipment, sports equipment, mechanical and electrical installations, firefighting, active and inactive methods of fire safety, medical and pharmaceutical industries, aerospace industries, recycling industries, and waste management, water and energy industries, oil and gas industries, paper and pulp industry, glass industry, food and beverage industries, toy industry, game equipment and supplies, ventilation and air conditioning technologies, urban development, industrial coating, decoration, automobile manufacturing, textile industry, carpentry, shipping, ship and boat building, packaging of industrial goods, medical industry, and laboratory equipment.

What is claimed is:

1. A method of manufacturing a multilayer self-healing polyester composite, comprising:
forming a tufted pile of polyester fibers on a top surface of a backing layer by tufting polyester yarns onto a backing layer, wherein the backing layer has the top surface and a bottom surface;
forming a layer of a multitude of yarn loops on the bottom surface of the backing layer simultaneously as forming the tufted pile of polyester; and
forming a solid polyester layer as an outer layer by subjecting the a top section of the tufted pile of polyester fibers formed on the top surface of the backing layer to a temperature exceeding the glass transition temperature (Tg) of the polyester material,
wherein the solid polyester outer layer is bonded to a remaining layer of the tufted pile of polyester fibers, and wherein the multitude of yarns loops of the bottom surface of the backing layer remain undistorted.

2. The method according to claim 1, wherein the height of the formed tufted pile of polyester on the top surface is between 0.1 and 30 cm.

3. The method according to claim 1, wherein the heating occurs at a temperature that exceeds the Tg of polyester and is below the melting temperature (Tm) of polyester.

4. The method according to claim 3, wherein the temperature is between 130 and 200° C.

5. The method according to claim 1, wherein the backing layer comprises a textured polyester.

6. The method according to claim 1, wherein forming the tufted pile of polyester fibers on the top surface of the backing layer is conducted at the same time as forming the layer of the multitude of yarn loops on the bottom surface of the backing layer.

7. The multi-layered self-healing polyester composite, comprising:
a backing layer comprises a textured polyester structure having a top surface and a bottom surface;
a middle layer comprising a tufted pile of polyester fibers on the top surface of the backing layer having a melting temperature (Tm) greater than 250° C.; and
an outer layer comprising a solid dense polyester layer bonded to the middle layer.

8. The multi-layered self-healing polyester composite according to claim 6, wherein the backing layer comprised of polyester warp yarns interwoven with weft polyester yarns.

9. A multi-layered self-healing composite, comprising:
a backing layer comprising a textured polyester structure having a top surface and a bottom surface;
a middle layer comprising a tufted pile of fibers, wherein the middle layer is tufted on the top surface of the backing layer, and comprising thermoplastic and thermoset polymer fibers having a glass transition temperature (Tg) between 130 and 200° C.; and
an outer layer comprising a solid dense layer bonded to the middle layer.

10. The multi-layered self-healing composite according to claim 9, wherein the thermoplastic polymer comprising one or more polyester, nylon, and polypropylene fibers.

11. The multi-layered self-healing composite according to claim 9, wherein the thermoplastic and thermoset polymer are bicomponent fibers.

12. The multi-layered self-healing composite according to claim 10, wherein the bicomponent fibers comprise polyester and cotton.

13. The multi-layered self-healing composite according to claim 11, wherein a ratio of polyester/cotton of the biocomponent fiber is 80/20.

14. The multi-layered self-healing composite according to claim 9, wherein a textured layer preferably warp yarns is interwoven with weft yarns.

15. The multi-layered self-healing composite according to claim 9, wherein the warp and weft yarns used in the backing layer comprising one or more of polyester, nylon, polypropylene, Kevlar, acrylic, cotton, wool, and silk.
